(19) United States
(12) Patent Application Publication
(10) Pub. No.: US 2023/0250891 A1
(43) Pub. Date: Aug. 10, 2023

(54) MAGNETICALLY REGULATED PRESSURE RELIEF VALVE

(71) Applicant: National Presto, Inc., Eau Claire, WI (US)

(72) Inventor: Julian Warwick, Jim Falls, WI (US)

(21) Appl. No.: 18/108,497

(22) Filed: Feb. 10, 2023

Related U.S. Application Data
(60) Provisional application No. 63/308,685, filed on Feb. 10, 2022.

(51) Int. Cl. F16K 31/08; F16K 31/06; F16K 17/12; A47J 27/09; A47J 36/10

(52) U.S. Cl. CPC F16K 31/084; F16K 31/0668; F16K 17/12; A47J 27/09; A47J 36/10

(57) ABSTRACT

A device for and method of releasing pressure from a pressure cooker using an arrangement of magnets that influence the opening and closing characteristics of a pressure relieve device used in a pressure cooker. The device configured using magnets which act to repel each other causing the pressure release valve to operating more quickly than valves relying on gravity to open.

### CROSS REFERENCE TO RELATED APPLICATIONS

This application claims priority to provisional patent application No. 63/308,685, filed on Feb. 10, 2022 which is incorporated herein by reference in its entirety.

### TECHNICAL FIELD

The present invention relates generally to a pressure indicating relief valve for use in pressure canners and pressure cookers.

### BACKGROUND

Pressure cookers and pressure canners are well known methods of cooking and canning foods. Pressure cookers can dramatically reduce the time require to cook certain foods as well as provide other benefits resulting from cooking food in a pressurized environment. Pressure canners allow for the higher temperatures required to safely preserve food. In order to cook foods using a pressure cooker, foods and liquids necessary to cook the foods are introduced into a pressure cooker that comprises of a sturdy pot, a lid that can be secured to the pot, and a gasket or other means to create a seal between the pot and the lid. Together these form a container capable of being pressurized, generally referred to as a pressure vessel. In addition, a pressure regulating device is provided. This is typically a weighted cover that is applied to the end of a tube structure formed in the lid portion of the pressure vessel. The weight is configured such that pressure builds up to a desired level inside the pressure vessel whereupon the weight lifts slightly or rocks such that steam escapes to regulate the pressure within the pressure vessel. Pressure cookers generally are provided with a safety valve such as a rubber plug that will eject from an opening formed in the pressure vessel to release pressure should the pressure regulating device fail.

Pressure canners are similar to pressure cookers in that they typically comprise elements similar to those identified in the previous paragraph which discussed pressure cookers. Some pressure canners may also include a pressure gage to enable a user to monitor the pressure within the pressure canner. Pressure canners are generally larger than pressure cookers so that the pressure vessel formed by the pressure canner can accommodate canning containers (commonly referred to as canning jars). Pressure canners enable the foodstuffs being canned to be heated to temperatures higher than the boiling point of water at a given altitude so as to safely can various foodstuffs.

Pressure cookers and canners build up pressure as liquid form steam as the result of the application of heat to the pressure cooker or canner. Particularly in the case of pressure canners, the pressure must be released in a controller manner at the end of the cooking or canning process. What is needed is a device for controlling the release of pressure from a pressure cooker or pressure canner such that the release is consistent despite varying conditions outside of the pressure vessel.

### SUMMARY

In exemplary embodiments, a pressure valve is formed in a lid portion of a pressure cooker or pressure canner. The pressure valve comprises a passageway from the interior to the exterior of a pressure cooker or canner. The passageway is configured with a slideable shaft that in certain embodiments comprise a pressure relief passageway. The slideable shaft is configured with a gasket flange that seals the passageway when the pressure inside the pressure cooker or canner reaches a predetermined level. The slideable shaft comprises a first magnet which is oriented to be magnetically repelled by a second magnet mounted along the movement path of the slideable shaft.

In exemplary embodiments, a pressure valve is formed in a lid portion of a pressure cooker or pressure canner. The pressure valve comprises a passageway from the interior to the exterior of a pressure cooker or canner. The passageway is configured with a slideable shaft that in certain embodiments comprise a pressure relief passageway. The slideable shaft is configured with a gasket flange that seals the passageway when the pressure inside the pressure cooker or canner reaches a predetermined level. The slideable shaft comprises a first magnet which is oriented to be magnetically attracted to a second magnet mounted along the movement path of the slideable shaft.

In another exemplary embodiment, a pressure valve comprises a passageway from the interior to the exterior of a pressure cooker or canner. The passageway is configured with a slideable shaft that in certain embodiments comprise a pressure relief passageway. The slideable shaft is configured with a relief port that extends from a portion of the shaft to an end of the shaft such that the port is covered when the shaft is in a first position in the passageway and uncovered such that pressure will be released via the shaft when the shaft is in second position in the passageway. The slideable shaft is configured with a gasket flange that seals the passageway when the pressure inside the pressure cooker or canner reaches a predetermined level. The slideable shaft comprises a first magnet which is oriented to be magnetically repelled by a second magnet mounted along the movement path of the slideable shaft.

In another exemplary embodiment, a pressure valve comprises a passageway from the interior to the exterior of a pressure cooker or canner. The passageway is configured with a slideable shaft that in certain embodiments comprise a pressure relief passageway. The slideable shaft is configured with a relief port that extends from a portion of the shaft to an end of the shaft such that the port is covered when the shaft is in a first position in the passageway and uncovered such that pressure will be released via the shaft when the shaft is in second position in the passageway. The slideable shaft is configured with a gasket flange that seals the passageway when the pressure inside the pressure cooker or canner reaches a predetermined level. The slideable shaft comprises a first magnet which is oriented to be magnetically attracted to a second magnet mounted along the movement path of the slideable shaft.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

These and other features and advantages of the present invention will become better understood with regard to the following description and accompanying drawings in which:

FIG. 1 shows a diagram of a known pressure cooker or canner;

FIGS. 2 and 3 illustrate a known pressure cooker or canner that includes a lid safety interlock in an unlocked and locked position;

FIG. 4 illustrates a diagram showing portion of FIG. 2 enlarged to show details of the lid safety interlock in an unlocked position;

FIG. 5 illustrates a diagram showing portion of FIG. 3 enlarged to show details of the lid safety interlock in a locked position;

FIGS. 6 and 7 illustrate characteristics of magnetic materials when oriented with regard to polarity;

FIG. 8 illustrates a diagram showing an enlarged portion of a pressure cooker or canner illustrated a lid safety interlock according to an exemplary embodiment in an unlocked position;

FIG. 9 illustrates a diagram showing an enlarged portion of a pressure cooker or canner illustrated a lid safety interlock according to an exemplary embodiment in a locked position;

FIG. 10 illustrates a graph of pressure in a pressure cooker or canner over a time period; and

FIG. 11 illustrates an alternate embodiment of the safety interlock according to an exemplary embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Pressure vessels have been used for food preparation and storage for many years. Both pressure canners and pressure cookers use the same principles with regard to causing a pressure increase in an enclosed space of a pressure vessel which is used to prepare or store food. Pressure canning requires that a person performing the canning process follow a series of steps regarding pressure and time in order to safely process canned food. In particular, the canning process requires bringing the pressure in a pressure canning vessel up to a certain pressure, maintaining that pressure for a certain period of time, and then allowing the pressure to decrease to a point at which the pressure canning vessel can be opened without disrupting the integrity of the containers used for canning or injuring the person performing the canning process. Because of this greater requirement of attention to detail required by the canning process as opposed to pressure cooking, the discussion herein will generally be related to pressure canners. Despite these references to pressure canners, certain embodiments of the invention are also applicable to pressure cookers.

Because water boils at 212 degrees Fahrenheit at sea level and the boiling temperature decreases as altitude is increased, pressurizing the heating environment is used to raise the boiling point of water to achieve temperatures higher than 212 degrees which are required to safely can certain foodstuffs. Pressure is achieved in a pressure canner through the application of heat to liquids found in the canner. Some embodiments are applicable to stovetop applications where the pressure canner does not generally include any electrical or electronic components. Such embodiments are generally heated on a gas, electric, or induction stovetop. Other embodiments may include electrical and electronic components that apply heat to a canning vessel, such embodiments might include control components that monitor temperatures or pressures of the canning vessel and provide control feedback to a heat source or other means of regulating the pressure inside of a canning vessel such as automated control valves. In pressure canning applications, the application of heat causes water and other liquids present in the canning vessel or foods to be canned to boil, releasing steam into the enclosed space of the pressure vessel. The result being that the pressure inside the pressure vessel increases such that water in the pressurized environment boils at temperatures higher than 212 degrees Fahrenheit. These higher temperatures are required to kill harmful bacteria such that the canned foods are safe to consume.

As heat is applied during the canning process, the pressure vessel may be vented to purge air such that the space inside the pressure vessel to completely fill with steam. The pressure vessel is then fully or partially sealed such that pressure can be regulated by the continued application of heat to the pressure vessel. This pressure is maintained while temperatures are increases to the required levels for canning. The pressure and temperatures are maintained for a period of time. After the required time has elapsed, the source of heat is removed and the temperature and pressure are allowed to reduce. When the pressure has reduced to a safe level, the pressure vessel can be opened. However, care must be taken that the pressure vessel is not opened too soon as steam and hot liquids could injure persons in the vicinity of the pressure vessel. A sudden decrease in pressure can also damage the canning containers such that they could leak with the result being potentially dangerous food contamination. As will be described in detail herein, exemplary embodiments provide a system and method that allows for the purging of air and a more precisely controlled release of pressure from the pressure vessel.

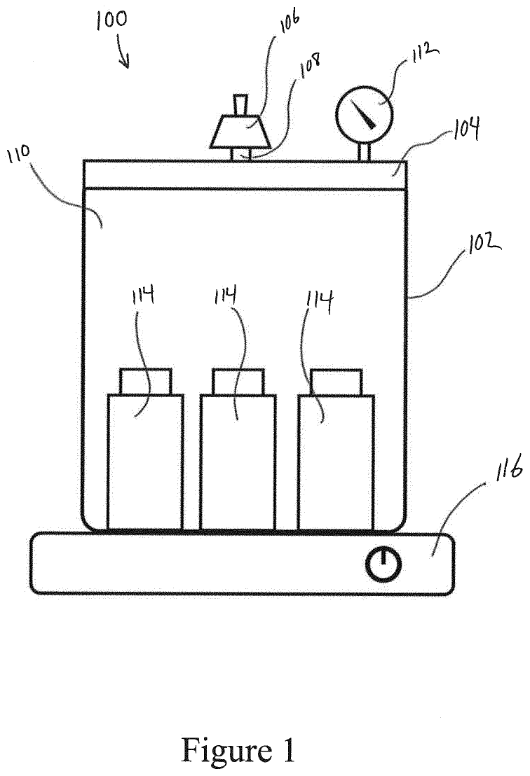

FIG. 1 illustrates a known pressure canner 100. As shown, the pressure canner 100 is composed of a body 102, a lid 104, a pressure regulator 106, and a regulator pipe 108 which is open to the interior 110 of the pressure canner 100. Pressure is regulated by the weight of the pressure regulator 106 which holds it against an outlet of the regulator pipe 108 such that a desired level of pressure is achieved. Certain pressure canners 100 also include a pressure indicator such as the pressure gauge 112 illustrated in FIG. 1. Cans 114 which are being processed in the pressure canner are placed inside the interior 110 of the pressure canner 100 and heat is applied from a stovetop or other heat source 116.

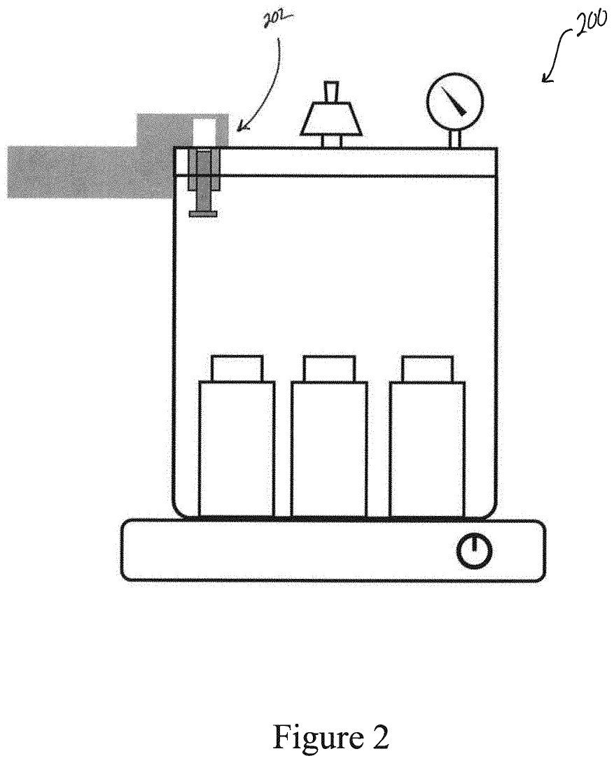

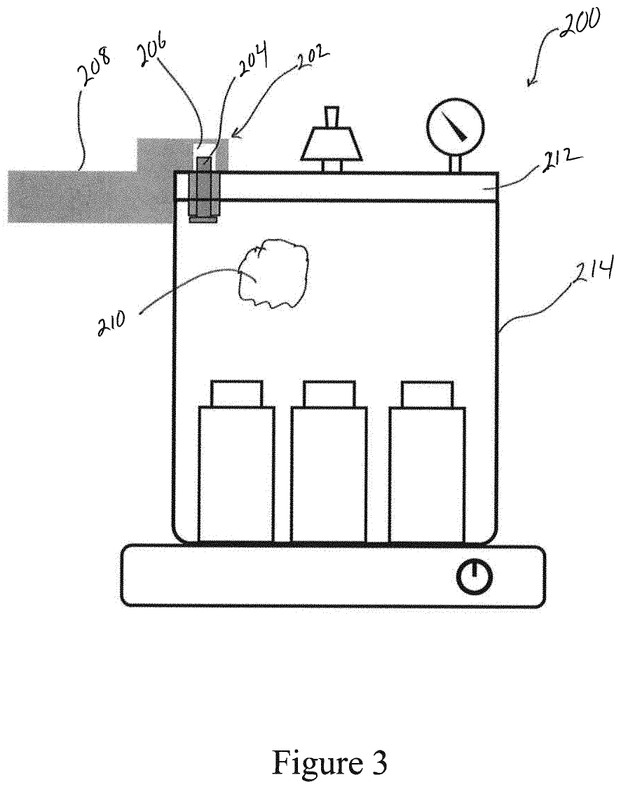

When in use, heat applied to the pressure canner 100 creates steam from liquids found in the interior 110 of the pressure canner 100, which in-turn causes pressure build up in the interior 110, removal of the lid 104 when pressure is present inside the pressure canner 100 can result in injury to the user as the result of pressurized steam being released. Thus it is desirable to prevent removal of the lid 104 until the pressure has been allowed to fall to safe levels. FIGS. 2 and 3 illustrate a safety interlock 202 that prevents the cover of a pressure canner 200 from being removed by the user before the pressure in the pressure canner 200 falls to safe levels. As shown in FIG. 3, an interlock pin 204 rises into a recess 206 formed in the handle portion 208 when pressure 210 rises in the pressure canner 200. As shown, when the interlock pin 204 is raised into the recess 206, the interlock pin 204 hits the wall of the recess 206, interfering with the rotation of the lid 212 which combines with a lid securing mechanism, generally formed by slots in the lid 212 and tabs on the body 214 (not shown), to prevent removal of the lid 212 from the body 214 of the pressure canner 200. When pressure 210 falls to a safe level, gravity causes the interlock pin 204 to drop out of the recess 206 as shown in FIG. 2, allowing the lid to be rotated and removed (not shown) from the body 214 of the pressure canner 200.

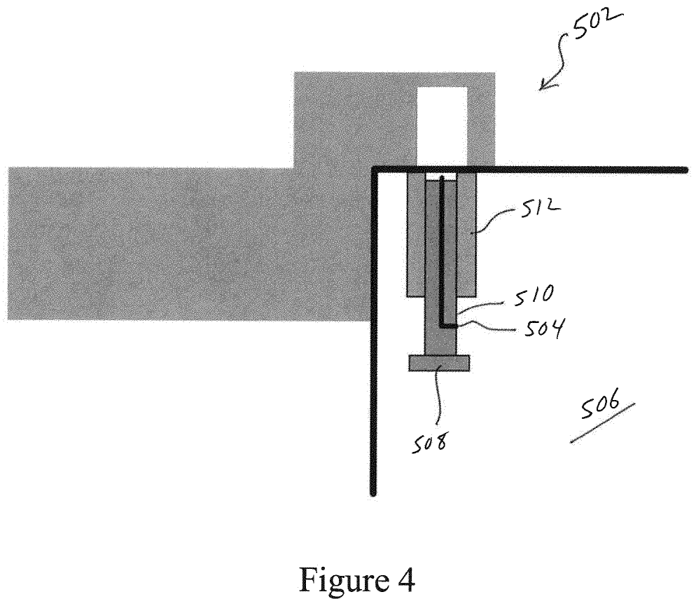

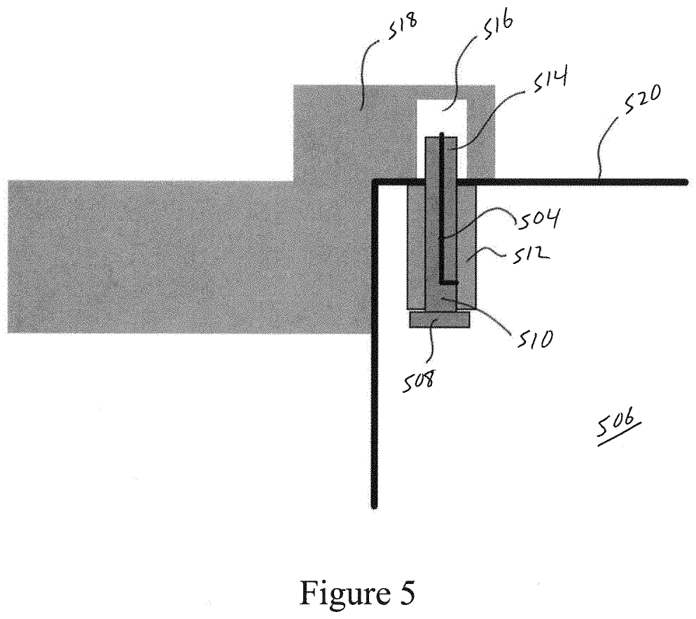

FIGS. 4 and 5 show an enlarged view of alternate safety interlock 502 which includes a pressure relief passage 504. As pressure builds up in the chamber 506 of the pressure canner, a small amount of that pressure escapes through the relief passage 504. However, as heat is applied to the pressure canner, pressure in the chamber 506 builds up faster than it can escape through the relief passage 504, causing the pressure to exert a force again a base portion 508 of the interlock pin 510. The result is the interlock pin 510 rising fully into the interlock shaft 512 as illustrated in FIG. 5. As shown in FIG. 5, a top portion 514 of the interlock pin 510 extends into the recess 516 formed in the handle portion 518 to prevent rotation of and thus removal of the lid portion 520. As is illustrated in FIG. 5, the entrance to the relief passage 504 is blocked by the interlock shaft 512 after the interlock pin 510 moves partially into the interlock shaft 512. This stops the loss of any pressure through the relief passage, causing the interlock pin 510 to complete its upward movement into the recess 516 and secure the lid 502 to the body of the pressure canner. When the pressurized portion of the canning process is complete, the heat source is removed from the pressure canner causing the pressure inside the chamber 506 to decline. As the pressure continues to decline, the pressure against the base 508 of the interlock pin 510 is reduced such that the interlock pin 510 begins to fall out of the interlock shaft 512. When the relief passage 504 is exposed to the chamber 506, the pressure remaining in the chamber 506 is allowed to escape via the relief passage 504 to the exterior of the pressure canner.

As shown in FIGS. 4 and 5, the interlock pin 510 is lifted from a first position to a second position by pressure formed inside a pressure canner. The act of raising the interlock pin 510 is a function of pressure exerted against the weight of the interlock pin 510 while the act of lowering the interlock pin is a function of the reduction of pressure to the point at which it no longer overcomes the weight of the interlock pin and the interlock pin 510 starts to fall back to the first position. As will be described in more detail herein, magnets can be used to alter the influences of gravity upon the interlock pin.

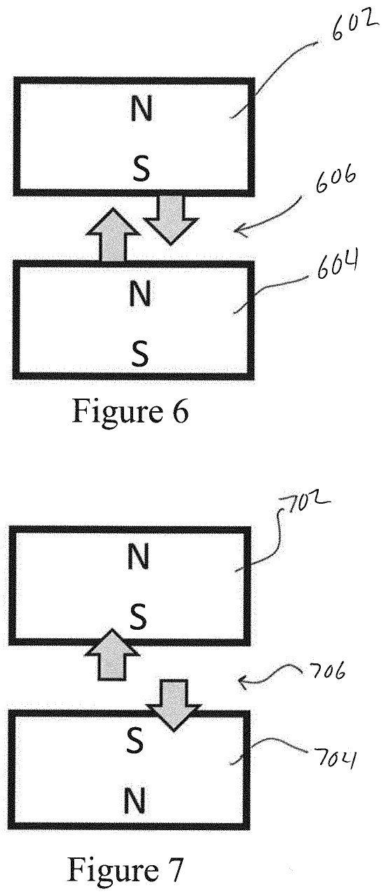

FIGS. 6 and 7 illustrate the behavior exhibited by two magnets as they are brought into proximity with each other in two arrangements. As is generally understood, a magnet has a positive and negative polarity. When a first magnet 602 is brought into close proximity with a second magnet 604 such that the “S” polarity of the first magnet 602 is adjacent to the “N” polarity of the second magnet 604, the magnets 602 & 604 are attracted to each other as illustrated by the arrows 606. As shown in FIG. 7, when a first magnet 702 is brought into proximity with a second magnet 704 such the adjacent polarities are the same (for example, both “S” as illustrated), the magnets 702 & 704 are repelled from each other. This repulsion is utilized by certain exemplary embodiments while other embodiments utilize the attraction of magnets when opposite polarities are brought together

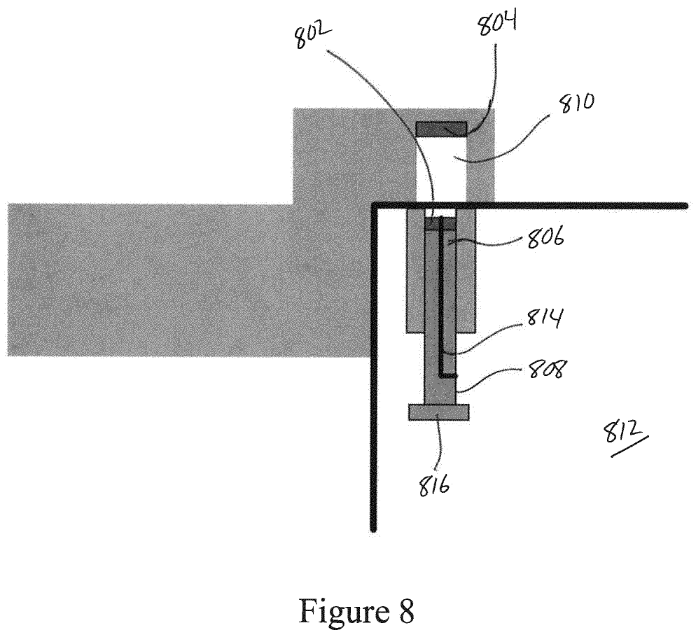

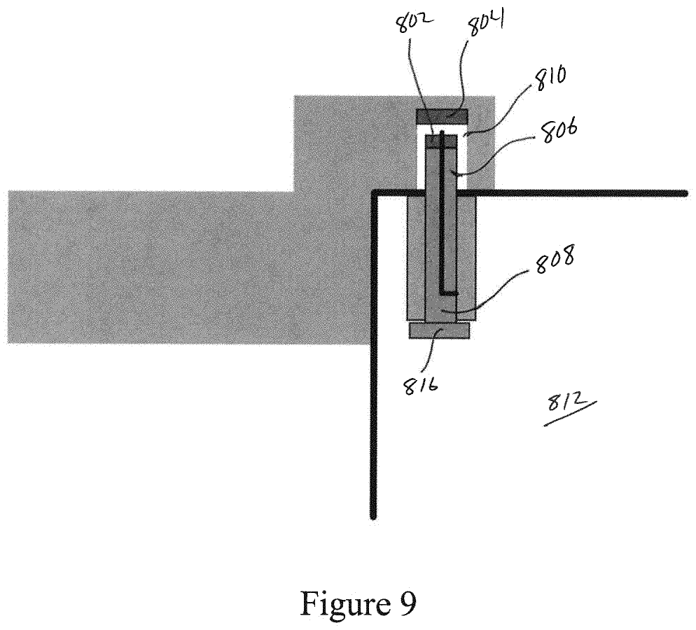

As illustrated in FIG. 8, in an exemplary embodiment a first magnet 802 is affixed to the top portion 806 of the interlock pin 808. A second magnet 804 is mounted at the top of handle recess 810. As shown in FIG. 8, when there is no pressure in the chamber 812, there is also no pressure exerted against the interlock pin 808. This allows the interlock pin 808 to rest at a first position as shown in FIG. 8. It should be noted that a relief passage 814 is illustrated in FIG. 8. This relief passage 814 functions in a manner similar to the relief passage of FIGS. 4 & 5. It should be noted that relief passages are not required in all embodiments. Although the polarities of magnets 802 and 804 are not illustrated, the magnets are arranged such that like polarities are facing each other such as is shown in FIG. 7. Thus, the first magnet 802 and the second magnet 804 tend to repel each other when they are brought into close proximity. In FIG. 8, the interlock pin 808 is in a first position such that the first magnet 802 and the second magnet 804 are not in such close proximity as to cause the first magnet 802 and the second magnet 804 to repel each other. As pressure is increased in the chamber 812, pressure begins to exert a force on the base 816 of interlock pin 808. As the pressure increases to a certain amount, the force exerted on the base 816 of interlock pin 808 overcomes the repulsion of first magnet 802 and the second magnet 804 and causes the top portion 806 of interlock pin 808 to rise into the handle recess 810 more slowly, allowing air to be expelled from the pressure chamber 812. As the pressure in the chamber 812 is reduced, the process illustrated in FIGS. 8 and 9 is reversed, such that once a certain level of pressure reduction is realized, the interlock pin 808 drops back to the position illustrated in FIG. 8, allowing the top portion 806 to move out of the handle recess 810, this exploits the location of the opening of the relief passage to permit a more rapid reduction in pressure via the relief passage 814. The movement of the top portion of the interlock pin 808 out of the handle recess also allows the lid portion of the pressure canner to be removed.

As was noted earlier herein, pressure canning exploits the ability to use an increase in pressure to raise the boiling point of water to using increased pressure. In order for the temperature to be consistent within the chamber 812, air must be expelled. Ordinarily this is done by leaving the regulator 106 off of the regulator pipe 108 (refer to FIG. 1) while heat is applied to the canner 102 until a steady stream of steam exits the regulator pipe. At that point, the regulator is applied and pressure starts to build in the chamber 110. Referring again to FIGS. 8 and 9, in an exemplary embodiment the strength of the first magnet 802 and the second magnet 804 can be adjusted such that the amount of pressure required to cause the interlock pin 808 to rise is increased slightly such that any air in the chamber 812 exits via the relief passage 814 prior to the interlock pin 808 rising into the handle recess. In this way, a user would not have to leave the regulator 106 off of the regulator pipe 108 and instead, in an exemplary embodiment the process of expelling air could be performed without user interaction. The use of a first magnet 802 and a second magnet 804 causes the interlock pin 808 to react more quickly to a decreasing pressure than would be the case when magnets are not used.

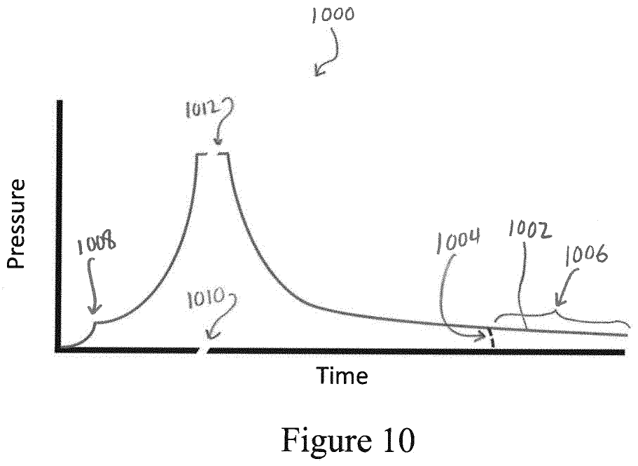

FIG. 10 illustrates a graph of pressure over time 1000 for an embodiment without a magnet 1002 and also shows the effect of a magnet on pressure release. As is illustrated, the release 1004 occurs when the pressure has been reduced to a relatively low level but using magnets to enhance response of a pressure release interlock pin 808 avoids the long tapering off 1006 of temperature which occurs in a conventional design. Thus, in exemplary embodiments, pressure is allowed to reduce to a safe level without an excessive waiting period before a pressure cooker can be opened. Also illustrated is the increase in pressure 1008 when the interlock pin 808 closes the relief passage 814 after air has been vented from the chamber 812. The broken section of the timeline 1010 and peak pressure 1012 indicate that ordinarily during the canning process, the peak pressure is maintained for a period of time that is greater than the time required for the pressure to rise or fall in order effectively kill bacteria found in the foodstuffs that are being canned.

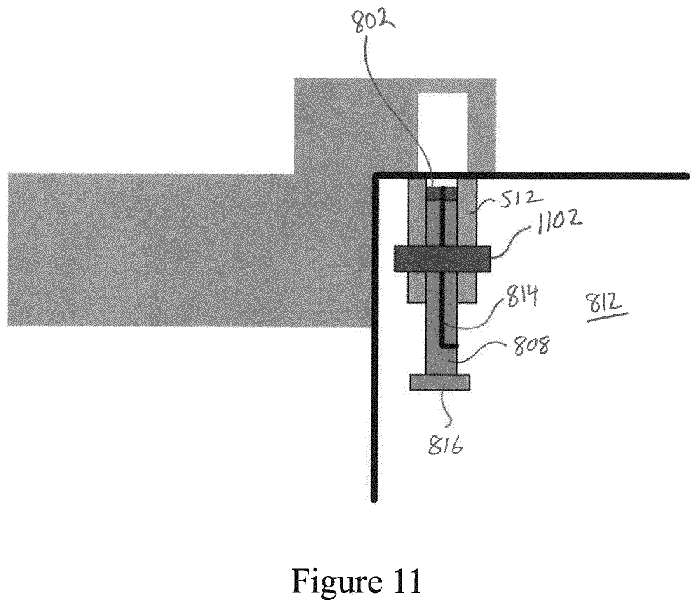

As was noted herein, an alternative embodiment exploits the attraction of magnets rather than the repulsion illustrated in the embodiments shown FIGS. 8 and 9. As illustrated in FIG. 11, an interlock pin 808 is configured with a relieve passage 814, a base 816, and a first magnet 802. In the illustrated embodiment, a second magnet 1102 is positioned along the interlock shaft 512 such that it attracts the first magnet 802. This configuration performs the same function as the embodiment illustrated in FIG. 8 but uses the attraction between the first magnet 802 and the second magnet 1102 to slightly resist the effect of pressure upon the base 816 of the interlock pin 808. Thus, the position and strength of the first magnet 802 and second magnet 1102 can be adjusted to cause the interlock pin 808 to react to pressures in a chamber 812 in a manner similar to that described herein with regard to FIGS. 8 and 9.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation or embodiment disclosed herein can be combined with any other implementation or embodiment, and references to “an implementation,” “some implementations,” “one implementation,” “an embodiment,” “some embodiments,” “certain embodiments,” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation or embodiment can be combined with any other implementation or embodiment, inclusively or exclusively, in any manner consistent with the aspects and implementations disclosed herein.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

What is claimed is:

1. A safety interlock device for releasing pressure from a pressurized cooker having an internal chamber, the safety interlock device comprising:
an interlock pin housed in an interlock shaft such that the interlock pin is movable from a first position to a second position;
a first magnet affixed to a first end of the interlock pin;
a second magnet positioned such that the movement of the first magnet is influenced by the second magnet;
a base positioned at the second end of the interlock pin such that pressure asserted against the base causes the interlock pin to move from the first position toward the second position.

2. The safety interlock device of claim 1, where when the interlock pin is in the second position, the internal chamber of the pressurized cooker cannot be accessed.

3. The safety interlock device of claim 2, further comprising a recess into which the interlock pin extends when in the second position.

4. The safety interlock device of claim 1, wherein the first magnet influences the second magnet using a repulsive force.

5. The safety interlock device of claim 1, wherein the first magnet influences the second magnet using an attractive force.

6. The safety interlock device of claim 1, wherein the interlock pin comprises a pressure relief passage which is obstructed when the interlock pin is in the second position.

7. A method of limiting access to an internal chamber of a pressurized cooking device, the method comprising:
providing an interlock pin housed in an interlock shaft where the interlock pin is in a first position in the absence of pressure in the internal chamber;
allowing the interlock pin to move to a second position when pressure is applied to the internal chamber;
affixing a first magnet to the interlock pin;
affixing a second magnet adjacent to the interlock pin such that movement of interlock pin is influenced by the second magnet.

8. The method of claim 7, further comprising causing the interlock pin, when in the second position, to interfere with removal of a portion of the pressurized cooker.

9. The method of claim 7, wherein the first magnet influences the second magnet using a repulsive force.

10. The method of claim 7, wherein the first magnet influences the second magnet using an attractive force.

11. The method of claim 7, further comprising allowing pressure to escape from the internal chamber of the pressurized cooking device.

12. The method of claim 11, wherein the pressure is allowed to escape through the interlock pin via a pressure relief passage which is obstructed when the interlock pin is in the second position.

13. A pressure cooking utensil comprising:
a body open at one end;
a lid which when applied to the body open end forms a chamber, the lid comprising an interlock shaft;
an interlock pin housed in the interlock shaft such that the interlock pin is movable from a first position to a second position, when the interlock pin is in the second position, the internal chamber of the pressurized cooking utensil cannot be accessed;
a first magnet affixed to a first end of the interlock pin;
a second magnet positioned such that the movement of the first magnet is influenced by the second magnet; and
a base positioned at the second end of the interlock pin such that pressure formed in the chamber asserts a force against the base causing the interlock pin to move from the first position toward the second position.

14. The pressure cooking utensil of claim 13, further comprising a recess into which the interlock pin extends when in the second position.

15. The pressure cooking utensil of claim 13, wherein the first magnet influences the second magnet using a repulsive force.

16. The pressure cooking utensil of claim 13, wherein the first magnet influences the second magnet using an attractive force.

17. The pressure cooking utensil of claim 13, wherein the interlock pin comprises a pressure relief passage which is obstructed when the interlock pin is in the second position.
